(19) United States
(12) Patent Application Publication
(10) Pub. No.: US 2009/0090770 A1
(43) Pub. Date: Apr. 9, 2009

(54) COMBINE IDENTITY TOKEN

(76) Inventor: Sudipta Chakrabarti, Foster City, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/868,838

(22) Filed: Oct. 8, 2007

(51) Int. Cl. G06K 5/00

(52) U.S. Cl. 235/380

(57) ABSTRACT

An apparatus and method is provided for using a single portable consumer device for purchase transactions, providing identification, and contacting a law enforcement agency. In one embodiment the present invention provides a portable consumer device comprising a body, a first memory containing financial information on the body, and a second memory containing driver license information on the body.

### CROSS-REFERENCES TO RELATED APPLICATIONS

Not Applicable

### BACKGROUND

There are many occasions in a typical purchase transaction where a consumer will need to provide identification and/or where a merchant will have to provide consumer identification information to a law enforcement agency regarding purchases that a particular consumer may make. This means that a consumer must always carry multiple cards; one or more for making the purchase and one or more for identification.

For example, a consumer may go to a drugstore to buy allergy medicine. The particular allergy medicine that the consumer chooses to buy may contain certain ingredients known to be used to make illegal drugs. A law enforcement agency may require that the merchant ask for and record the consumer's identification information so that the law enforcement agency can track purchases to be sure that any one individual is not purchasing large quantities of the allergy medicine. If a consumer does not bring appropriate identification with him to make the purchase, he may not be able to purchase the allergy medication or have to choose another medication that does not contain the particular ingredients.

Embodiments of the invention address the above problems, and other problems, individually and collectively.

### BRIEF SUMMARY

Embodiments of the invention are directed to an apparatuses, systems, and methods using a single portable consumer device for purchase transactions, providing identification, and contacting a law enforcement agency.

In one embodiment, the present invention provides a portable consumer device comprising a body, a first memory containing financial information on the body, and a second memory containing driver license information on the body.

Another embodiment of the invention is directed to a method comprising obtaining a portable consumer device, using the portable consumer device to perform a purchase transaction, and using the portable consumer device to contact a law enforcement agency.

### BRIEF DESCRIPTION OF THE DRAWINGS

FIG. 1 shows a front view of a portable consumer device according to an embodiment of the invention.

FIG. 2 shows a back view of a portable consumer device according to an embodiment of the invention.

FIG. 3 shows a back view of a portable consumer device according to an embodiment of the invention.

FIG. 4 shows a block diagram of a portable consumer device according to an embodiment of the invention.

FIG. 5 shows a block diagram of a system according to an embodiment of the invention.

### DETAILED DESCRIPTION

Embodiments of the invention allow entities such as merchants and consumers to use a single portable consumer device to conduct purchase transactions, provide identification, and to contact a law enforcement agency.

The portable consumer device may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular and mobile phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card). Such portable consumer devices can have one or more antennas that can transmit and/or receive signals and data through a wireless communication medium.

An exemplary portable consumer device according to an embodiment of the invention may include at least two, three, four, or more separate memories holding different kinds of data. The memories may comprise any suitable types of technologies. For example, one memory may be in the form of a memory chip while a second memory may be in the form of a magnetic strip. Each type of memory may have a different type of information.

In one example, a first memory may be in the form of a memory chip coupled to an antenna (for performing contactless transactions), and may contain information such as financial information or identification information. Financial information may include information such as bank account information, bank identification number (BIN), expiration date, card verification value (CVV), credit or debit card number information, account balance information, consumer information, etc. Identification information may include identifying characteristics such as name, address, driver license number, sex, hair color, eye color, height, weight, driver license number, date of birth, expiration date of identification information, photograph, etc. A second memory in the form of a magnetic strip may comprise driver license information. In some cases, a third memory in the form of a second magnetic stripe might include rewards information associated with a particular merchant.

The portable consumer devices according to embodiments of the invention can be used with authorized readers that can also have antennas. Such authorized readers may be present at point of sale (POS) terminals, ATM (automatic teller machines), and the like. Such readers are well known in the art.

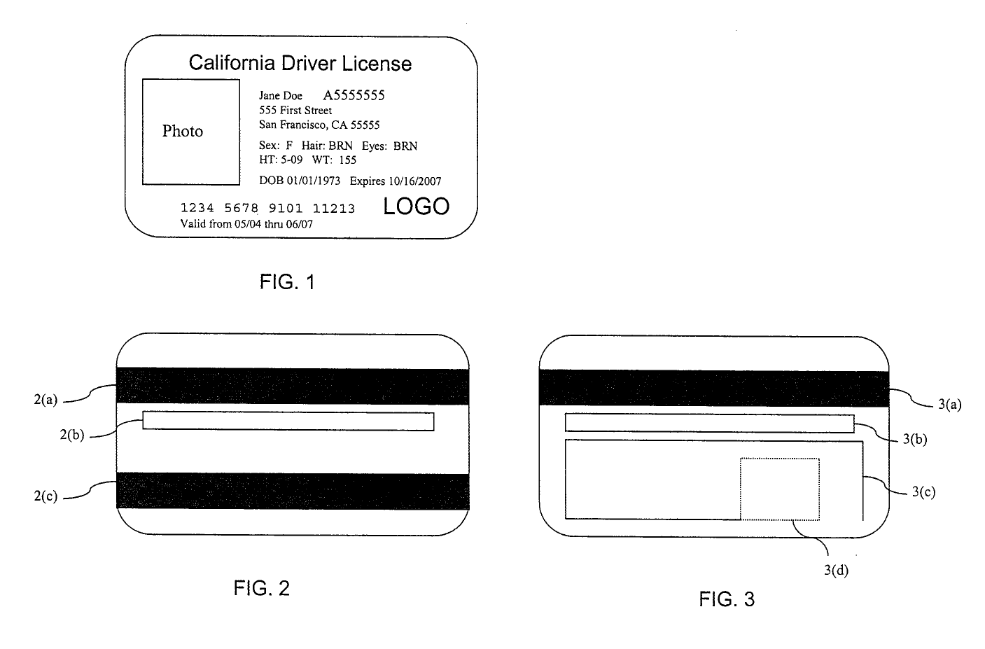

In one embodiment of the invention the portable consumer device is in the form of a card that includes a first side shown in FIG. 1 and two different embodiments of a second side shown in FIGS. 2 and 3.

FIG. 1 shows a first side of a portable consumer device that is in an identification card or credit card form. This side of the portable consumer device may contain identification information such as the portable consumer device user's photograph, name, address, sex, hair color, eye color, height, weight, and date of birth. It may also contain a driver license or identification number and expiration date of the identification information. It may further contain a financial or company logo (e.g., Visa, XYZ Credit Union, etc.), an account number (e.g., a credit card or debit card number) and the dates through which the account is valid.

FIG. 2 shows a second side of the portable consumer device that may contain a first memory 2(a) that may be in the form of a magnetic strip, a space for a portable consumer user's signature 2(b), and a second memory that may also be a magnetic strip 2(c). Either the first memory 2(a) or the second memory 2(b) may contain financial information or identification or driver license information. While only two memories are shown in FIG. 2, it is understood that embodiments of the invention may include multiple memories of the same or different technologies.

FIG. 3 shows an alternative second side of the portable consumer device that may contain a first memory 3(a) that may be in the form of a magnetic strip, a space for a portable consumer user's signature 3(b), an antenna 3(c), and a second memory 3(d) that may in the form of a memory chip. Either the first memory 3(a) or the second memory 3(d) may contain financial information or identification or driver license information. The antenna 3(c) in the portable consumer device 8 may be in any suitable form including a coil. While only two memories are shown in FIG. 3, it is understood that embodiments of the invention may include multiple memories of the same or different technologies.

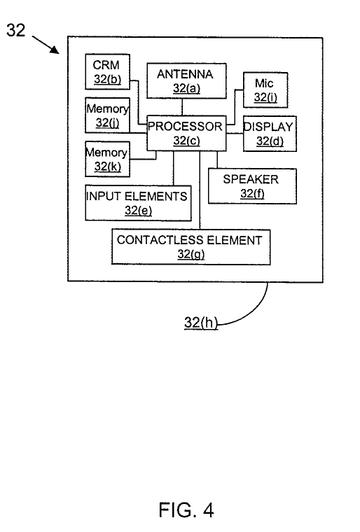

FIG. 4 shows a portable consumer device that can be used in an embodiment of the invention. The portable consumer device 32 may comprise a computer readable medium 32(b) and a body 32(h). The computer readable medium 32(b) may be present within body 32(h), or may be detachable from it. The body 32(h) may in the form a plastic substrate, housing, or other structure. The computer readable medium 32(b) may be a memory that stores data and may be in any suitable form including a magnetic strip, a memory chip, etc. If the computer readable medium 32(b) is in a phone, it may comprise code for performing a purchase transaction and code for contacting a law enforcement agency.

The portable consumer device 32 may comprise a first memory 320), and a second memory 32(k). The memories 320) and 32(k) may be present within body 32(h), or may be detachable from it. Each of the memories 320) and 32(k) may be a memory that stores data and may be in any suitable form including a magnetic strip, a memory chip, etc. One memory may contain financial information, and the other memory may contain identification information. While only two memories are shown in FIG. 4, it is understood that embodiments of the invention may include multiple memories of the same or different technologies.

The portable consumer device 32 may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 32 and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

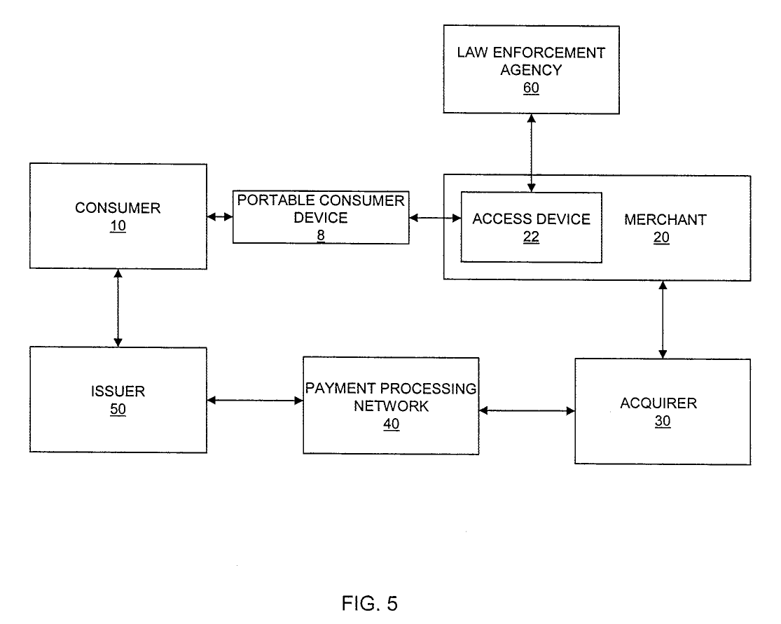

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 32 and a payment processing network 40 (see FIG. 5) or it can be used to exchange data between the portable consumer device 32 and a law enforcement agency 60 or it can be used to exchange data between the portable consumer device 32 and a merchant 20. Thus, the portable consumer device 32 is capable of communicating and transferring data and/or control instructions via both cellular network and near field communications capability.

The portable consumer device 32 may also include a processor 32(c) (e.g., a microprocessor) for processing the functions of the portable consumer device 32 and a display 32(d) to allow a consumer to see phone numbers and other information and messages. The portable consumer device 32 may further include input elements 32(e) to allow a consumer to input information into the device, a speaker 32(f) to allow the consumer to hear voice communication, music, etc., and a microphone 32(i) to allow the consumer to transmit her voice through the portable consumer device 32. The portable consumer device 32 may also include an antenna 32(a) for wireless data transfer (e.g., data transmission).

FIG. 5 shows a system that can be used in an embodiment of the invention. For simplicity of illustration, one consumer, one portable consumer device, one access device, one merchant, one acquirer, one payment processing network, one issuer, and one law enforcement agency are shown. It is understood, however, that embodiments of the invention may include multiple consumers, portable consumer devices, access devices, merchants, acquirers, payment processing networks, issuers, and/or law enforcement agencies. In addition, some embodiments of the invention may include fewer than all of the components shown in FIG. 5. Also, the components in FIG. 5 may communicate via any suitable communication medium (including the Internet), using any suitable communication protocol.

The system in FIG. 5 includes a merchant 20 and an acquirer 30 associated with the merchant 20. In a typical payment transaction, a consumer 10 may purchase goods or services at the merchant 20 using a portable consumer device 8 to interact with the access device 22. The acquirer 30 may be in operative communication with an issuer 50 of the portable consumer device 8 via a payment processing network 40. The merchant 20 can be in operative communication with a law enforcement agency 60 via any suitable communication medium (Including the Internet).

The acquirer 30 is typically a bank that has a merchant account. The issuer 50 may also be a bank, but could also be a business entity such as a retail store. Some entities are both acquirers and issuers, and embodiments of the invention include such entities.

The consumer 10 may be an individual, or an organization such as a business that is capable of purchasing goods or services. The consumer 10 may use a portable consumer device 8. The portable consumer device 8 may be in any suitable form as described above.

The payment processing network 40 is located between (in an operational sense) the acquirer 30 and the issuer 50. It may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 40 may use any suitable wired or wireless network, including the Internet.

The merchant 20 may be an individual or an organization such as a business that is capable of providing goods and services.

The merchant 20 may have one or more additional access devices 22. Suitable access devices include interfaces and may include point of sale (POS) devices, cellular phones, PDAs, personal computers (PCs), tablet PCs, handheld specialized readers, set-top boxes, electronic cash registers (ECR), automated teller machines (ATM), virtual cash registers (VCR), kiosks, security systems, access systems, and the like. They can interact with portable consumer devices. For example, a consumer 8 using a credit card to purchase a good or service can swipe it through an appropriate slot in the POS terminal. Alternatively the POS terminal may be a contactless reader, and the portable consumer device 8 may be a contactless device such as a contactless card.

The law enforcement agency 60 may include the department of motor vehicles (DMV), police department, or other similar agencies.

In a typical purchase transaction, the consumer 10 purchases a good or service at the merchant 20 using a portable consumer device 8. For example, a consumer may go to his local merchant 20 (e.g., drugstore or pharmacy) to purchase allergy medication. The consumer's portable consumer device 8 can interact with an access device 22 such as a POS (point of sale) terminal at the merchant 20. For example, the consumer 10 may take a card that contains credit card and driver license information and swipe it through an appropriate slot in the POS terminal.

Alternatively, the POS terminal may be a contactless reader, and the portable consumer device 8 may be a contactless device such as a contactless card or phone. For example, the consumer 10 may take a contactless card or a phone that is a contactless device and pass it in front of the contactless reader to transmit financial or identification information.

If transmitting financial information, an authorization request message is then forwarded to the acquirer 30. After receiving the authorization request message, the authorization request message is then sent to the payment processing network 40. The payment processing network 40 then forwards the authorization request message to the issuer 50 of the portable consumer device 8.

After the issuer 50 receives the authorization request message, the issuer 50 sends an authorization response message back to the payment processing network 40 to indicate whether or not the current transaction is authorized. The payment processing network 40 then forwards the authorization response message back to the acquirer 30. The acquirer 30 then sends the response message back to the merchant 20.

After the merchant 20 receives the authorization response message, the access device 22 at the merchant 20 may then provide the authorization response message for the consumer 8. The response message may be displayed by the POS terminal, may be printed out on a receipt, or may be displayed on the portable consumer device 8 such as on a phone display.

At the end of the day, a normal clearing and settlement process can be conducted by the payment processing network 40. A clearing process is a process of exchanging financial details between an acquirer and an issuer to facilitate posting to a consumer's account and reconciliation of the consumer's settlement position. Clearing and settlement can occur simultaneously.

If the merchant 20 is also required to request identification information from the consumer 10 for law enforcement tracking purposes, then the consumer device 8 can interact with the access device 22 to transmit identification information to the law enforcement agency. For example, the consumer 10 may take a card that contains credit card and driver license information and may swipe it through an appropriate slot in the POS terminal. Alternatively the POS terminal may be a contactless reader, and the portable consumer device 8 may be a contactless device such as a contactless card or phone. The consumer 10 may pass the contactless device in front of the POS terminal. The access device 22 may then transmit the identification information and the purchase information to the law enforcement agency 60.

Embodiments of the invention have a number of advantages. First, by providing two separate memories with law enforcement data and financial data, respectively, such data are not mixed. By not mixing data, the unauthorized collection of one type of data does not necessarily mean that the other type of data is also comprised. For example, if the law enforcement data are illegally copied from a portable consumer device, the financial data may not be copied. Also, providing financial data and law enforcement data in one portable consumer device makes the portable consumer device more convenient for a user as the user need not carry separate devices for financial information and law enforcement information.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A portable consumer device comprising:
a body;
a first memory containing financial information on the body; and
a second memory containing driver license information on the body.

2. The portable consumer device of claim 1 wherein the first memory is in the form of a memory chip and the second memory is in the form of a magnetic strip.

3. The portable consumer device of claim 1 wherein the driver license information includes a name, address, sex, hair color, eye color, height, weight, date of birth, expiration date, driver license number, photograph and combinations thereof.

4. The portable consumer device of claim 1 wherein the first memory is in the form of a first magnetic strip and the second memory is in the form of a second magnetic strip.

5. The portable consumer device of claim 1 wherein the body is a plastic sheet.

6. The portable consumer device of claim 1 wherein the financial information comprises a bank identification number (BIN), expiration date, and card verification value (CVV).

7. The portable consumer device of claim 1 wherein the portable consumer device is in the form of a phone.

8. The portable consumer device of claim 1 further comprising a picture on the body.

9. The portable consumer device of claim 1 wherein the first memory is in the form of a memory chip and the second memory is in the form of a memory chip.

10. A method comprising:
obtaining the portable consumer device of claim 1;
using the portable consumer device to perform a purchase transaction; and
using the portable consumer device to contact a law enforcement agency.

11. The method of claim 10 wherein the portable consumer device is in the form of a card.

12. The method of claim 10 wherein the portable consumer device is in the form of a phone.

13. The method of claim 10 wherein the law enforcement agency includes the department of motor vehicles (DMV) and police department.

14. A computer readable medium comprising:
code for using the portable consumer device to perform a purchase transaction; and
code for using the portable consumer device to contact a law enforcement agency.
